(19) United States
(12) Patent Application Publication
(10) Pub. No.: US 2002/0146589 A1
(43) Pub. Date: Oct. 10, 2002

(54) Organic electroluminescent device and light-emitting material

(76) Inventors: Kimio Akiyama, Miyagi (JP); Koro Shirane, Chiba (JP)

Correspondence Address: Sughrue Mion, 2100 Pennsylvania Avenue NW, Washington, DC, 20037-3213, US

(21) Appl. No.: 10/031,454

(22) PCT Filed: May 21, 2001
(86) PCT No.: PCT/JP01/04202

(30) Foreign Application Priority Data
May 22, 2000 (JP) 2000/149299

(51) Int. Cl. H05B 33/14; C09K 11/06

(52) U.S. Cl. 428/690; 428/917; 428/212; 313/504; 313/506; 257/101; 257/102; 252/301.16

(57) ABSTRACT

The invention relates to a light-emitting material and organic electroluminescent (EL) device having high emitting efficiency, in which two organic compounds that contribute to the light emission are used. These two organic compounds have a relationship among energy levels in the excited state, such that an energy transfer takes place from the excited triplet state of one compound to the excited triplet state of the other compound. The organic EL device and light-emitting material of the invention have high emitting efficiency, high luminance and durability, can surpass the marginal value of 25% in the internal quantum efficiency conventionally acknowledged for the light-emitting materials used in organic EL devices, and can be applicable to all emission colors considered necessary for a display.

### CROSS REFERENCE TO THE RELATED APPLICATIONS

This is an application based on the prescription of 35 U.S.C. Section 111(a) with claiming the benefit of filing dates of U.S. Provisional applications Serial No. 60/221,486 filed Jun. 14, 2000 under the provision of 35 U.S.C.111(b), pursuant to 35 U.S.C. Section 119(e)(1).

### TECHNICAL FIELD

The present invention relates to an organic electroluminescent device (hereinafter simply referred to as an “organic EL device”) for flat panel displays or backlights used therein.

### BACKGROUND ART

The organic EL device was first reported on its high-luminance emission by C. W. Tang et al of Kodak in 1987 (see, Appl. Phys. Let., Vol. 51, page 913 (1987)). Since then, an abrupt progress has been proceeding in the development of materials and improvement of device structures and in recent years, the organic EL device is actually used in a display for car audios or cellular phones. In order to more expand the use of this organic EL, development of materials for improving the emitting efficiency or durability or development of full color displays are being aggressively made at present. Particularly, on considering the use wide-spreading to the medium- or large-size panel or illumination, the high luminance must be more intensified by improving the emitting efficiency. However, the currently known light-emitting materials use light emission from the excited singlet state, namely, fluorescence, and according to Monthly Display, “Organic EL Display”, extra number, page 58 (October, 1988), the generation ratio of the excited singlet state to the excited triplet state upon electric excitation is 1:3. Therefore, the internal quantum efficiency in the fluorescence emission has been acknowledged to have an upper limit of 25%.

On the other hand, M. A. Baldo et al. have reported that an external quantum efficiency of 7.5% (assuming that the external coupleout efficiency is 20%, the internal quantum efficiency is 37.5%) can be obtained by using an iridium complex capable of emitting phosphorescence from the excited triplet state and thus, the conventionally acknowledged upper limit of 25% can be surpassed (see, Appl. Phys. Lett., Vol. 75, page 4 (1999)). However, such a material that is capable of stably emitting phosphorescence at an normal temperature like the iridium complex used there is very rare, and on use, the material must be disadvantageously doped into a specific host compound for electrical excitation. As a result, great difficulties are encountered in selecting a material for realizing the light-emission wavelength necessary for displays.

Furthermore, the same M. A. Baldo et al. have reported that relatively good emitting efficiency can be obtained by using an iridium complex as a sensitizer, transferring the energy from the excited triplet state to the excited singlet state of a fluorescent dye, and finally emitting fluorescence from the excited singlet state of the fluorescent dye (see, Nature, Vol. 403, page 750 (2000)). This method is advantageous in that a light-emitting material well matching the purpose can be selected from a large number of fluorescent dyes. However, this method has a serious problem that it involves energy transfer from the excited triplet state of a sensitizer to the excited singlet state of a fluorescent dye, which is a spin-forbidding process, so that the emission quantum efficiency is low in principle.

As such, existing light-emitting materials for use in an organic EL device cannot succeed in surpassing the conventionally acknowledged marginal value of 25% in the internal quantum efficiency and being applicable to all emission colors considered necessary for a display. A material having high emitting efficiency is demanded also from the standpoint of improving the durability of the device because such a material causes little energy loss and the device can be prevented from heat generation. An object of the present invention is to solve those problems in conventional techniques and provide a high-luminance organic EL device having durability and a light-emitting material for use in the device.

### DISCLOSURE OF THE INVENTION

As a result of extensive investigations to solve the above-described problems, the present inventors have found that when two kinds of organic compounds contributing to light emission are used and these two kinds of organic compounds have a relationship with respect to the energy level in the excited state such that energy transfer takes place from the excited triplet state of one compound to the excited triplet state of the other compound, high-efficiency light emission can be achieved. The present invention has been accomplished based on this finding.

That is, the present invention relates to the following organic electroluminescent devices and light-emitting materials for use in the devices.

1. An organic electroluminescent device comprising a light-emitting layer containing two or more organic compounds, wherein out of the organic compounds, two organic compounds are conditioned such that an energy level E1_{T1} of a first organic compound in a lowest excited triplet state is higher than an energy level E2_{S1} of a second organic compound in a lowest excited singlet state, at least one energy level of the second organic compound in an excited triplet state is present between E1_{T1} and E2_{S1}, and light is emitted from the second organic compound.

2. An organic electroluminescent device comprising a light-emitting layer containing three or more organic compounds, wherein out of the organic compounds, three organic compounds are conditioned such that an energy level E1_{T1} of a first organic compound in a lowest excited triplet state is higher than an energy level E2_{S1}, of a second organic compound in a lowest excited singlet state, at least one energy level of the second organic compound in an excited triplet state is present between E1_{T1} and E2_{S1}, the energy level E1_{S1} in the lowest excited singlet state and the energy level E1_{T1} in the lowest triplet state of the first organic compound have the following relationship with an energy level E3_{S1}, in a lowest excited singlet state and an energy level E3_{T1} in a lowest excited triplet state of a third organic compound:

E3ₛ₁>E1_{S1}

E3_{T1}>E1_{T1}

and light is emitted from the second organic compound.

3. An organic electroluminescent device comprising an anode, a light-emitting layer described in 1 or 2 above and a cathode in this order.

4. An organic electroluminescent device comprising an anode, a hole transport layer, a light-emitting layer described in 1 or 2 above, an electron transport layer and a cathode in this order.

5. The organic electroluminescent device as described in any one of 1 to 4 above, wherein the light emission from the second organic compound is fluorescence.

6. The organic electroluminescent device as described in any one of 1 to 5 above, wherein the first organic compound is a transition metal complex.

7. The organic electroluminescent device as described in any one of 1 to 5 above, wherein the first organic compound is a rare earth metal complex.

8. A light-emitting material comprising a light-emitting layer containing two or more organic compounds, wherein out of the organic compounds, two organic compounds are conditioned such that an energy level E1_{T1} of a first organic compound in a lowest excited triplet state is higher than an energy level E2_{S1} of a second organic compound in a lowest excited singlet state, at least one energy level of the second organic compound in an excited triplet state is present between E1_{T1} and E2_{S1}, and light is emitted from the second organic compound.

9. A light-emitting material comprising a light-emitting layer containing three or more organic compounds, wherein out of the organic compounds, three organic compounds are conditioned such that an energy level E1_{T1} of a first organic compound in a lowest excited triplet state is higher than an energy level E2_{S1} of a second organic compound in a lowest excited singlet state, at least one energy level of the second organic compound in an excited triplet state is present between E1_{T1} and E2_{S1}, the energy level E1_{S1} in the lowest excited singlet state and the energy level E1_{T1} in the lowest triplet state of the first organic compound have the following relationship with an energy level E3_{S1} in a lowest excited singlet state and an energy level E3_{T1} in a lowest excited triplet state of a third organic compound:

E3ₛ₁>E1_{S1}

E3_{T1}>E1_{T1}

and light is emitted from the second organic compound.

10. The light-emitting material as described in any one of 8 or 9 above, wherein the light emission from the second organic compound is fluorescence.

11. The light-emitting material as described in any one of 8 to 10 above, wherein the first organic compound is a transition metal complex.

12. The light-emitting material as described in any one of 8 to 10 above, wherein the first organic compound is a rare earth metal complex.

### BRIEF DESCRIPTION OF THE DRAWINGS

FIG. 1 is a cross-sectional view showing an example of the organic EL device of the present invention.

FIG. 2 is an explanatory view showing the relationship among energy levels of the organic compounds constituting the light-emitting layer of the organic EL device according to the first embodiment of the present invention.

FIG. 3 is an explanatory view showing the relationship among energy levels of the organic compounds constituting the light-emitting layer of the organic EL device according to the second embodiment of the present invention.

### MODE FOR CARRYING OUT THE INVENTION

The operation mode of the present invention is specifically described below by referring to the drawings attached hereto.

FIG. 1 is a cross-sectional view showing one example of the structure of the organic EL device according to the present invention, where a hole transport layer (3), a light-emitting layer (4) and an electron transport layer (5) are provided in this order between an anode (2) provided on a transparent substrate (1) and a cathode (6). The organic EL device structure is not limited to this example shown in FIG. 1 but either one of 1) a hole transport layer/a light-emitting layer and 2) a light-emitting layer/an electron transport layer may be provided in this order or only one of 3) a, layer containing a hole transport material, a light-emitting material and an electron transport material, 4) a layer containing a hole transport material and a light-emitting material, 5) a layer containing a light-emitting material and an electron transport material, and 6) a layer containing only a light-emitting material may be provided. The light-emitting layer shown in FIG. 1 comprises one layer but may comprise a laminate of two or more layers.

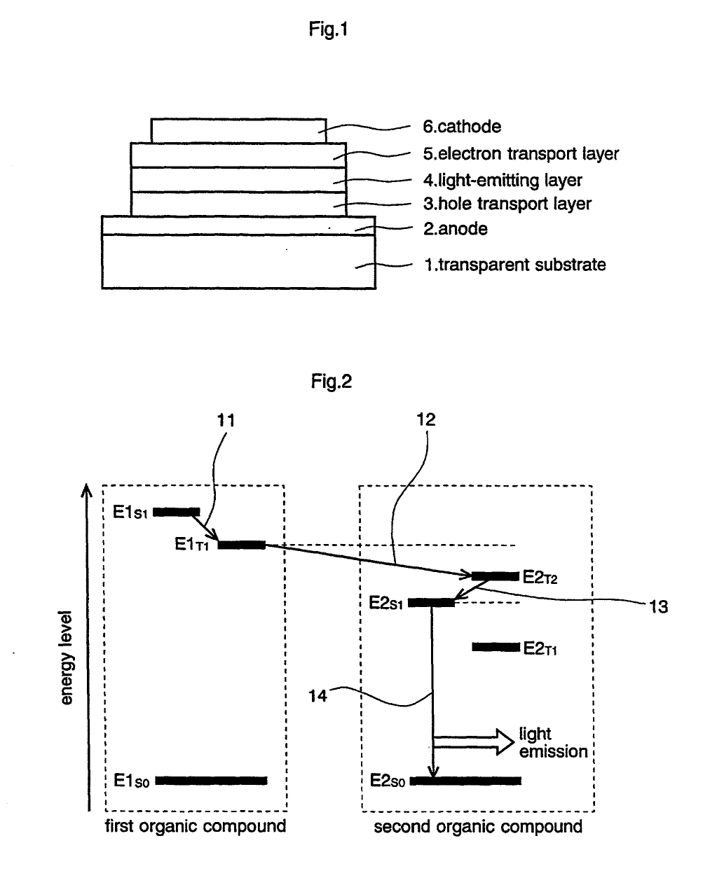

FIG. 2 shows the relationship among the energy levels of the organic compounds constituting the llght-emitting layer of the organic EL device according to the first embodiment of the present invention. The light-emitting layer of the organic EL device shown in FIG. 2 contains at least two organic compounds, namely, a non-emitting first organic compound and a light -emitting second organic compound. These compounds have a relationship such that the energy level E1_{T1} in the lowest excited triplet state of the first organic compound is higher than the energy level E2_{S1} in the lowest excited singlet state of the second organic compound and at least one energy level in the excited triplet state of the second organic compound is present between E1_{T1} and E2_{S1}. In the example shown in FIG. 2, the second lowest energy level E2_{T2} in the excited triplet state of the second organic compound is present between E1_{T1} and E2_{S1}. However, one or a plurality of the third and subsequent lowest energy levels in the excited triplet state of the second organic compound may be present between E1_{T1} and E2_{S1}.

The first organic compound is preferably a compound capable of readily causing intersystem crossing from the excited singlet state to the excited triplet state and having liability to emit phosphorescence. The quantum efficiency in the intersystem crossing is preferably 0.1 or more, more preferably 0.3 or more, and still more preferably 0.5 or more.

Specific examples of the compound include transition metal complexes and rare earth metal complexes. However, the present invention is by no means limited thereto.

Examples of the transition metal used in the transition metal complexes include Cr, Mn, Fe, Co, Ni, Ru, Rh, Pd, Os, Ir and Pt. However, the present invention is by no means limited thereto. The term “transition metal” is used herein by taking account of even the ion state of the elements and the first transition series reaches Cu(II), the second transition series reaches Ag(II) and the third transition series reaches Au(II).

Examples of the rare earth metal used in the rare earth metal complexes include La, Nd, Sm, Eu, Gd, Tb, Dy, Er and Lu. However, the present invention is by no means limited thereto.

Examples of the ligand used in the transition metal complex or rare earth metal complex include acetylacetonato, 2,2′-bipyridine, 4,4′-dimethyl-2,2′-bipyridine, 1,10-phenanthroline, 2-phenylpyridine, porphyrin and phthalocyanine. However, the present invention is by no means limited thereto. A kind of these ligands or kinds of these ligands is(are) coordinated to one complex.

The above-described complex compound may also be a polynuclear complex or a composite complex of two or more complexes.

For the second organic compound, fluorescence-emitting compounds including conventionally known various dyes may be used. In particular, those which readily cause reverse intersystem crossing from the excited triplet state to the excited singlet state are preferred. The quantum efficiency in the reverse intersystem orossingis preferably 0.1 or more, more preferably 0.3 or more, and still more preferably 0.5 or more. Examples of such compounds include 9,10-dibromoanthracene having a quantum efficiency in the reverse intersystem crossing of 0.19 (see, H. Fukumura et al., J. Photochem. Photobiol., A: Chemistry, Vol. 42, page 283 (1988)), and merocyanine 540 having a quantum efficiency in the reverse intersystem crossing of about 0.7 and analogous cyanine dyes (see, R. W. Redmond et al., J. Phys. Chem., A, Vol. 101, page 2773 (1997)). However, the present invention is by no means limited thereto.

In the organic EL device according to the first embodiment, the light-emitting layer contains the above-described first organic compound and second organic compound. In this case, the first organic compound and the second organic compound may be contained in one layer or may be individually contained in separate layers. These two layers or more layers may be laminated to form one light-emitting layer. Also, the layers each may contain a compound other than the first organic compound and the second organic compound. The thickness of the light-emitting layer is preferably from 10 nm to 1 μm, more preferably from 10 to 100 nm.

In the first embodiment, when the relationship shown in FIG. 2 is present among the energy levels, the light is emitted by the following mechanism. The first organic compound is electrically excited and finally forms excitations in the lowest excited singlet state (energy level E1_{S1}) and those in the lowest excited triplet state (energy level E1_{T1}) at a ratio of 25%:75%. The lowest excited singlet state shifts to the lowest excited triplet state by the intersystem crossing 11 and the ratio of the lowest triplet state increases to 75% or more.

Then, an energy transfer 12 takes place from the lowest excited triplet state (energy level E1_{T1}) of the first organic compound to the second lowest excited triplet state (energy level E2_{T2}) of the second organic compound or to the third or subsequent lowest excited triplet state (not shown). An energy transfer may occur from the lowest excited singlet state (energy level E1_{S1}) of the first organic compound to the excited singlet state (energy level E2_{S1}) of the second organic compound. However, since the ratio of the lowest excited singlet state (energy level E1_{S1}) of the first organic compound is lower than 25% as a result of the intersystem crossing, this energy transfer little contributes on the whole.

Thereafter, the second lowest excited triplet state (energy level E2_{T2}) or the third or subsequent lowest excited triplet state (not shown) of the second organic compound shifts to the lowest excited singlet state (energy level E2_{S1}) of the second organic compound by the reverse intersystem crossing 13 and in the process 14 of transition therefrom to the ground state (energy level E2_{S0}), fluorescence is emitted.

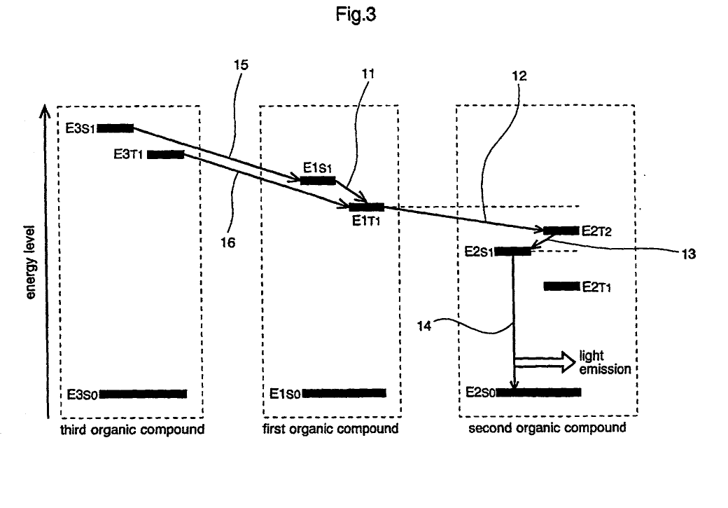

FIG. 3 shows the relationship among the energy levels of the organic compounds constituting the light-emitting layer of an organic EL element according to the second embodiment of the present invention. The relationship of energy levels shown in FIG. 3 contains the relationship with the energy levels of the third organic compounds further contained in the light-emitting layer, in addition to the relationship among the energy levels of the first organic compound and the second organic compound shown in FIG. 2. More specifically, the relationship is such that the energy level E3_{S1} in the lowest excited singlet state of the third organic compound is higher than the energy level E1_{S1} in the lowest excited singlet state of the first organic compound and at the same time, the energy level E3_{T1} in the lowest excited triplet state of the third organic compound is higher than the energy level E1_{T1} in the lowest excited triplet state of the first organic compound.

The third organic compound is not particularly limited as long as it satisfies the above-described relationship of energy levels.

In the organic EL device according to the second embodiment, the light-emitting layer contains the first organic compound, the second organic compound and the third organic compound. The first organic compound, the second organic compound and the third organic compound may be contained in one layer. Also, one or two compound(s) out of these three compounds may be contained in one layer and these two or more layers may be laminated to form a light-emitting layer. These layers each may contain a compound other than the first organic compound, the second organic compound and the third organic compound. The thickness of the light-emitting layer is preferably from 10 nm to 1 μm, more preferably from 10 to 100 nm.

In the second embodiment, when the relationship shown in FIG. 3 is present among the energy levels, the light is emitted by the following mechanism. The third organic compound is electrically excited and finally forms excitations in the lowest excited singlet state (energy level E3_{S1}) and those in the lowest excited triplet state (energy level E3_{T1}) at a ratio of 25%:75%.

Then, an energy transfer 15 takes place from the lowest excited singlet state (energy level E3_{S1}) of the third organic compound to the lowest excited singlet state (energy level E1_{S1}) of the first organic compound. Or, an energy transfer takes place from the lowest excited singlet state (energy level E3_{S1}) of the third organic compound to the second or subsequent lowest excited singlet state (not shown) of the first organic compound and further, due to the internal conversion, transition to the lowest excited singlet state (Energy level E1_{S1}) occurs. On the other hand, an energy transfer 16 takes place from the lowest excited triplet state (energy level E3_{T1}) of the third organic compound to the lowest excited triplet state (energy level E1_{T1}) of the first organic compound. Or, an energy transfer takes place from the lowest excited triplet state (energy level E3_{T1}) of the third organic compound to the second or subsequent lowest excited triplet state (not shown) of the first organic compound and further, due to the internal conversion, transition to the lowest excited triplet state (energy level E1_{T1}) occurs.

Thereafter, according to the same mechanism as in the first embodiment, transition from the lowest excited singlet state (energy level E1_{S1}) to the lowest triplet state (energy level E1_{T1}) of the first organic compound takes place by the intersystem crossing 11. From this, an energy transfer 12 takes place to the second lowest excited triplet state (energy level E2_{T2}) or the third or subsequent lowest excited triplet state (not shown) of the second organic compound, and after the transition to the lowest excited singlet state by reverse intersystem crossing 13, fluorescence is emitted in the process 14 of returning to the ground state.

As the hole transport material for forming the hole transport layer of the organic EL device according to the present invention, a triphenylamine derivative such as TPD (N,N′-diphenyl-N,N′-(3-methylphenyl)-1,1′-biphenyl-4,4′-diamine), α-NPD (N,N′-diphenyl-N,N′-(1-naphthyl)-1,1′-biphenyl-4,4′-diamine) or m-MTDATA (4,4′,4″-tris-[N-(3-methylphenyl)-N-phenylamino]triphenylamine), or a known hole transport material such as polyvinyl carbazole and polyethylene dioxythiophene may be used. However, the present invention is by no means limited thereto. These hole transport materials may be used individually or may be used by mixing or laminating it with a different hole transport material. The thickness of the hole transport layer varies depending on the electric conductivity of the hole transport layer and cannot be indiscriminately specified but it is preferably from 10 nm to 10 μm, more preferably from 10 nm to 1 μm.

As the electron transport material for forming the electron transport layer of the organic EL device according to the present invention, a quinolinol derivative metal complex such as Alq_{3 (tris(}8-quinolinol) aluminum), or a known electron transport material such as an oxadiazole derivative and a triazole derivative, may be used. However, the present invention is by no means limited thereto. These electron transfer materials may be used individually or may be used by mixing or laminating it with a different electron transfer material. The thickness of the electron transfer layer varies depending on the electric conductivity of the electron transport layer and cannot be indiscriminately specified but it is preferably from 10 nm to 10 μm, more preferably from 10 nm to 1 μm.

The organic compound for use in the light-emitting layer, the hole transport material and the electron transport material each may form respective layers by itself or using a polymer material as the binder. Examples of the polymer material which can be used for this purpose include polymethyl methacrylate, polycarbonate, polyester, polysulfone and polyphenylene oxide. However, the present invention is by not means limited thereto.

The organic compound for use in the light-emitting layer, the hole transport material and the electron transport material each may be formed into a film by a resistance heating vacuum evaporation, an electron beam vacuum evaporation method, a sputtering method or a coating method. However, the present invention is by no means limited to these methods. In the case of a low molecular compound, resistance heating vacuum evaporation or electron beam vacuum evaporation is predominantly used, and in the case of a high molecular material, a coating method is predominantly used.

For the anode material of the organic EL device according to the present invention, known transparent electrically conducting materials may be used, such as ITO (indium tin oxide), tin oxide, zinc oxide, and conductive polymers such as polythiophene, polypyrrole and polyaniline. However, the present invention is by no means limited thereto. The electrode formed of this transparent electrically conducting material preferably has a surface resistance of from 1 to 50 ohm per square. The anode material may be formed into a film by an electron beam vacuum evaporation method, a sputtering method, a chemical reaction method or a coating method. However, the present invention is by no means limited to these methods. The anode preferably has a thickness of from 50 to 300 nm.

Between the anode and the hole transport layer or the organic layer laminated adjacently to the anode, a buffer layer may be interposed for the purpose of relaxing the injection barrier against the hole injection. For this purpose, known materials such as copper phthalocyanine may be used. However, the present invention is by no means limited thereto.

For the cathode material of the organic EL device according to the present invention, known cathode materials may be used and examples thereof include Al, MgAg alloy, alkali metals such as Ca, and Al-alkali metal alloys such as AlCa. However, the present invention is by no means limited thereto. The cathode material may be formed into a film using a resistance heating vacuum evaporation method, an electron bean vacuum evaporation method, a sputtering method or an ion plating method. However, the present invention is by no means limited thereto. The cathode preferably has a thickness of from 10 nm to 1 μm, more preferably from 50 to 500 nm.

Between the cathode and the electron transport layer or the organic layer laminated adjacently to the cathode, an insulating layer having a thickness of from 0.1 to 10 nm may be interposed so as to improve the electron injection efficiency. For the insulating layer, known materials such as lithium fluoride, magnesium fluoride, magnesium oxide and alumina may be used. However, the present invention is by no means limited thereto.

In the adjacency to the cathode side of the light-emitting layer, a hole blocking layer may be provided so as to prevent holes from passing through the light-emitting layer but efficiently recombine the holes with electrons within the light-emitting layer. For this purpose, known materials such as a triazole derivative and an oxadiazole derivative may be used. However, the present invention is by no means limited thereto.

For the substrate of the organic EL device according to the present invention, an insulating substrate transparent to the light-emission wavelength of the light-emitting material may be used and examples thereof include glass and known materials such as transparent plastics including PET (polyethylene terephthalate) and polycarbonate. However, the present invention is by no means limited thereto.

Matrix type or segment type pixels can be fabricated by a known method in the organic EL device of the present invention, or the EL device may be used as a backlight without forming pixels.

### BEST MODE FOR CARRYING OUT THE INVENTION

Hereinafter, the present invention will be described in detail by examples and comparative examples. However, the present invention is by no means limited thereby.

The measurement items and measuring method in the examples and comparative examples are as follows.

<Thickness>

The thickness of organic layers was measured using DEKTAK 3030 (a stylus type profilometer) produced by SLOAN Co.

<Emission Spectrum of Solution>

The emission spectrum of a light-emitting material in a solution state was measured using a spectrofluorometer FP-6500 produced by JASCO Corp.

<Intensity of Fluorescence>

The intensity of fluorescence emitted by laser irradiation was measured as follows. The light emitted from a sample was introduced into a monochromator (Type 270, produced by McPherson Co.) to disperse the fluorescence, and the dispersed lights were detected by a photomultiplier (R636, produced by Hamamatsu Photonics Co.). The outputs were observed on a digital oscilloscope (Type 9450, produced by Lecroy Co.) and analyzed on a personal computer.

<Energy Level in the Excited Triplet State>

A compound to be measured (hereinafter, referred to as “compound A”) and a quencher are dissolved in a solvent and a first pulse laser having a wavelength at which the compound A has an absorption and a pulse width sufficiently shorter than the lifetime of the excited triplet state of compound A is irradiated to the resulting solution. As a result, there occurs in the compound A the lowest excited triplet state (energy level Ea_{T1}) through the lowest excited singlet state (energy level Ea_{S1}) and the lowest excited triplet state lasts after irradiation of the pulse laser.

Then, while it is still in the lowest excited triplet state (but after the fluorescence was quenched), the compound A in the lowest excited triplet state is irradiated with a second pulse laser having a wavelength at which the compound A has an absorption. As a result, the compound A is excited to a triplet state (Ea_{Tn}) at a higher energy level. In this context, compound A causes reverse intersystem crossing. In the absence of quencher, compound A, transiting from this higher energy level (Ea_{Tn}) to the lowest excited singlet state (Eaₛ₁) in the reverse intersystem crossing, emits fluorescence.

Next, cases where a quencher is present will be described.

First, in the case where there is among the energy levels of the compound A in the excited triplet an energy level higher than the energy level Ea_{S1} of the compound A in the lowest excited singlet state and lower than the energy level Eq_{f1} of the quencher in the lowest excited triplet state (Ea_{S1}<Ea_{Tn}<Eq_{T1}), this excited triplet state is not vulnerable to deactivation by the quencher. As a result, the compound A shifts from the higher excited triplet state (Ea_{Tn}) to the lowest excited singlet state (Ea_{S1}) due to reverse intersystem crossing and emits fluorescence therein.

On the contrary, in the case where there is among the energy levels of the compound A in the excited triplet no energy level higher than the energy level Ea_{S1} of the compound A in the lowest excited singlet state and lower than the energy level Eq_{T1} of the quencher in the lowest excited triplet state, the compound A is excited to the excited triplet state of an energy level higher than the energy level Eq_{T1} of the quencher in the lowest excited triplet state by the irradiation of the second pulse laser (Ea_{Tn}>Eq_{T1}). However, this excited triplet state is vulnerable to deactivation by the quencher so that after the transition from the higher excited triplet state by reverse intersystem crossing, the fluorescence emitted from the lowest excited singlet state is weakened or quenched.

Therefore, in the case where the fluorescence intensity from the compound A observed upon irradiation with the second pulse laser in the presence of a quencher exhibits fluorescence having an equivalent intensity to that of the fluorescence emitted from the compound A (without any quencher), it is understood that there exists an excited triplet state having an energy level (Ea_{S1}<Ea_{Tn}<Eq_{T1}) between the energy level Ea_{S1} of the compound A in the lowest excited singlet state and the energy level Eq_{T1} of the quencher in the lowest excited triplet state.

On the other hand, in the case where the fluorescence intensity from the compound A observed upon irradiation with the second pulse laser in the presence of a quencher is weak as compared with that of the fluorescence emitted from the compound A (without any quencher) or no fluorescence is observed, it is understood that there exists no excited triplet state having an energy level between the energy level Ea_{S1} of the compound A in the lowest excited singlet state and the energy level Eq_{T1} of the quencher in the lowest excited triplet state.

The measurement described above was repeated using quenchers having different energy states in the lowest excited triplet state to determine the ranges of energy levels (Ea_{TN≧2}) of excited triplet state higher than the energy level of the compound A in the lowest excited triplet state.

<Emitting Luminance>

As the power source, a programmable direct current voltage/current source TR6143 produced by Advantest Co. Ltd. was used to apply voltage to the organic electroluminescent devices obtained in the examples and comparative examples. The emitting luminance was measured using a luminance meter BM-8 produced by Topcon Co., Ltd.

### EXAMPLE 1

(1) Measurement of energy level El_{T1} of fac-tris(2-phenylpyridine) iridium in the lowest excited triplet state

fac-Tris(2-phenylpyridine)iridium was synthesized according to the synthesis method described in K. Dedeian et al., Inorganic Chemistry, Vol. 30, No. 8, page 1685 (1991).

A 10⁻⁵ M fac-tris(2-phenylpyridine)iridium chloroform solution was prepared and emission spectrum thereof was measured using a spectrofluorometer. As a result, the peak wavelength of phosphorescent spectrum was 510 nm, from which the energy level El_{T1} of the lowest excited triplet state was determined to be 19,600 cm⁻¹ (1/510×10⁻⁷).

(2) Measurement of energy level E2_{S1} of Rhodamine 101 in the lowest excited singlet state

Rhodamine 101 purchased from Fluka Co. was used without further purification.

A 10⁻⁵ M Rhodamine 101 methanol solution was prepared and emission spectrum was measured using a spectrofluorometer As a result, the peak excitation wavelength was 570 nm and peak fluorescence wavelength was 590 nm. From these, the energy level E2_{S1} of the lowest excited singlet state was determined to be 17,100 cm⁻¹ ((1/570×10⁻⁷+(1/590×10⁻⁷)+2) by taking an average.

(3) Measurement of T-T absorption spectrum of Rhodamine 101

Irradiation of the second pulse laser was performed at a wavelength at which Rhodamine 101 in the lowest excited triplet state has an absorption. To determine this, measurement of absorption spectrum in the lowest excited triplet state, i.e., T-T absorption spectrum, was performed by a conventionally used transient absorption measurement method (see, for example, Course on Experimental Chemistry, 4^{th} ed., Vol. 7, Spectroscopy II, page 275, 1992, Maruzen).

A 10⁻⁵ M Rhodamine 101 methanol solution was prepared, to which was irradiated second harmonic (wavelength: 532 nm, output: 15 mJ/pulse, pulse width: 5 nsec) from Nd:YAG laser (GCR14, produced by Spectra Physics Co.) to generate the lowest excited triplet state and T-T absorption spectrum in this state was measured. As a result, a broad peak was observed at 600 nm. From this, the wavelength of the second pulse laser was determined to be 690 nm.

(4) Measurement of second and subsequent energy levels E2_{Tn≧2} of Rhodamine 101 in the excited triplet state

A 10⁻⁵ M Rhodamine 101 methanol solution was prepared, to which was irradiated second harmonic (wavelength: 532 nm, output: 15 mJ/pulse, pulse width: 5 nsec) from Nd:YAG laser (GCR14, produced by Spectra Physics Co.). After 15 μsec, excimer laser excited dye laser (Hyper DYE 300, produced by Lumonics Co., wavelength: 690 nm, output 5 mJ/pulse, pulse width: 20 nsec) was irradiated. As a result, fluorescence was observed. In the case where the first pulse laser was not irradiated, no fluorescence was observed. From these, it is understood that fluorescence was emitted due to reverse intersystem crossing from the excited triplet state having high energy level to the lowest excited singlet state of Rhodamine 101.

Then, Rhodamine 101 and β-ionone as a quencher were dissolved in methanol. The concentrations were adjusted to 10⁻⁵ M for Rhodamine 101 and 10⁻² M for β-ionone. The energy level Eq_{T1} of β-ionone in the lowest excited triplet state was known to be 19,200 cm⁻¹ from “Handbook of Photochemistry, Second Edition (Steven L. Murov et al., Marcel Dekker Inc., 1993).

To this solution was irradiated the second harmonic (wavelength: 532 nm, output: 15 mJ/pulse, pulsewidth: 5 nsec) from Nd:YAG laser (GCR14, produced by Spectra Physics Co.). After 15 μsec, excimer laser excited dye laser (Hyper DYE 300, produced by Lumonics Co., wavelength: 690 nm, output 5 mJ/pulse, pulse width: 20 nsec) was irradiated. As a result, there was observed fluorescence having an intensity of the same level as in the case where no β-ionone was present. In addition, when the concentration of β-ionone was increased up to 1 M, no quenching occurred and similarly, fluorescence having an intensity of the same level as in the case where no β-ionone was present was observed.

From the above, Rhodamine 101 was demonstrated to have an excited triplet state at an energy level higher than 17,100 cm⁻¹, i.e., the energy level E2_{S1} of the lowest excited singlet state, since it emits fluorescence due to reverse intersystem crossing. Since fluorescence was not quenched in the presence of β-ionone, it was also demonstrated to have an excited triplet state (E2_{Tn}) at an energy level lower than 19,200 cm⁻¹, i.e., the energy level of β-ionone in the lowest excited triplet state.

Therefore, it was demonstrated that Rhodamine 101 has an excited triplet state at an energy level between 17,100 cm⁻¹ and 19,200 cm⁻¹.

(5) Fabrication of EL Device

An organic EL device was fabricated using an ITO-precoated substrate which had two stripes of ITO electrodes of 4 mm in width on one side of a 25 mm square glass (Nippo Electric Co., Ltd.).

First, on the ITO (anode) of ITO-provided substrate was coated poly(3,4-ethylenedioxythiophene)polystyrene sulfonate (“Baytron P”, trade name, produced by Bayer AG) by spin coating method under the conditions of 3,500 rpm and a coating time of 40 seconds and then the coated substrate was dried at 60° C. for 2 hours under reduced pressure in a vacuum drier to form an anode buffer layer. The thickness of the obtained anode buffer layer was about 50 nm.

Then, a coating solution for forming a layer containing a hole transport material, a light-emitting material, and an electron transport material was prepared. The light-emitting material, hole transport material, electron transport material and solvent were mixed in compounding ratios shown in Table 1 and the obtained solution was filtered through a filter with an aperture diameter of 0.2 μm to obtain a coating solution. Each of the materials, synthesized preparations by the inventors or purchased preparations, was used without further purification.

Light-emitting material (1):

fac-Tris(2-phenylpyridine) iridium

(the above synthesized preparation)

Light-emitting material (2):

Rhodamine 101 (produced by Fluka Co.)

Hole transport material:

Poly(N-vinylcarbazole)

(produced by Tokyo Kasei Co.)

Electron transport material:

2-(4-Biphenyl)-5-(4-tert-butylphenyl)-1,3,4-oxadiazole(PBD)

(produced by Tokyo Kasei, Co.)

Solvent: Chloroform

(Wako Pure Chemical Industry Co., special grade)

Then, the prepared coating solution was coated on the anode buffer layer by a spin coating method under the conditions of 3,000 rpm and a coating time of 30 seconds and dried at room temperature (25° C.) for 30 minutes to form a layer containing the hole transport material, light-emitting material, and electron transport material. The obtained layer containing the hole transport material, light-emitting material, and electron transport material had a thickness of about 120 nm.

Then, the substrate on which the layer containing the hole transport material, light-emitting material, and electron transport material was formed was placed in a vacuum evaporation apparatus, and silver and magnesium were co-deposited in weight ratios of 1:10 to form two cathodes of 3 mm in width arranged in the form of a stripe in the direction perpendicular to the direction in which the two stripe-shaped anodes (ITO) extended. The obtained cathode had a thickness of about 50 nm.

Finally, in argon atmosphere, a lead wire (wiring) was attached to the anode and cathode to fabricate 4 organic EL devices of a size of 4 mm long×3 mm wide.

(6) Evaluation of Light-emitting Property

To the organic EL devices described above was applied voltage, and light-emitting luminance were measured. As a result, a light emitting luminance of 22 cd/r² was obtained when a voltage of 20 V was applied.

### COMPARATIVE EXAMPLE 1

Organic EL devices were fabricated in the same manner as in the Example 1 above except that the coating solution for forming the layer containing the hole transport material, light-emitting material, and electron transport material was formulated as shown in Table 1. In the Comparative Example 1, no fac-tris(2-phenylpyridine)iridium was used.

To the organic EL devices described above was applied voltage, and light-emitting luminance were measured. As a result, a light emitting luminance of 3 cd/m² was obtained when a voltage of 20 V was applied.

TABLE 1

Compounding amount (mg)

| | | | Comparative |
|---|---|---|---|
| | | Example 1 | Example 1 |
| Light- | Fac-tris(2- | 0.02 | — |
| emitting | phenylpyridine) | | |
| material | iridium | | |
| | Rhodamine 101 | 0.10 | 0.10 |
| Hole transport | Poly(N- | 15.88 | 15.88 |
| Material | vinylcarbazole) | | |
| Electron | PBD | 4.00 | 4.00 |
| transport | | | |
| Material | | | |
| Solvent | Chloroform | 1980 | 1980 |

| | | |
|---|---|---|
| Light-emitting luminance(cd/m²) | 22 | 3 |

### EXAMPLE 2

Organic EL devices were fabricated in the same manner as in the Example 1 above, except that Nile Red (produced by Across Co.) was used instead of Rhodamine 101 and that the coating solution for forming the layer was formulated as shown in Table 2. The peak excitation wavelength of Nile Red was 560 nm and peak fluorescence wavelength was 590 nm. From these, the energy level E2_{S1} of the lowest excited singlet state was determined to be 17,400 cm⁻¹ ((1/560×10⁻⁷ +(1/590×10⁻⁷)+2) by taking an average.

The first pulse laser(second harmonic from YAG laser) and second pulse laser were irradiated, and emission of luminance due to reverse intersystem crossing was observed.

With respect to the second excited triplet states and thereafter, luminance was not quenched even in the presence of β-ionone as a quencher. Therefore, it was demonstrated that Nile Red has an excited triplet state at an energy level between 17,400 cm⁻¹ and 19,200 cm⁻¹.

To the organic EL devices described above was applied voltage, and light-emitting luminance were measured. As a result, a light emitting luminance of 52 cd/m² was obtained when a voltage of 24 V was applied.

### COMPARATIVE EXAMPLE 2

Organic EL devices were fabricated in the same manner as in the Example 2 above except that the coating solution for forming the layer was formulated as shown in Table 2. In the comparative Example 2, no fac-tris (2-phenylpyridine) iridium was used.

To the organic EL devices described above was applied voltage, and light-emitting luminance were measured. As a result, a light emitting luminance of 33 cd/m² was obtained when a voltage of 24 V was applied.

TABLE 2

Compounding amount (mg)

| | | | Comparative |
|---|---|---|---|
| | | Example 2 | Example 2 |
| Light- | fac-tris(2- | 0.02 | — |
| emitting | phenylpyridine) | | |
| material | iridium | | |
| | Nile Red | 0.10 | 0.10 |
| Hole transport | Poly(N- | 15.88 | 15.88 |
| Material | vinylcarbazole) | | |
| Electron | PBD | 4.00 | 4.00 |
| transport | | | |
| Material | | | |
| Solvent | Chloroform | 1980 | 1980 |

| | | |
|---|---|---|
| Light-emitting luminance(cd/m²) | 52 | 33 |

The above results demonstrate that by satisfying the relationship that for the two organic compounds contained in the light-emitting layer, the energy level E1₁ of a first compound in the lowest excited triplet state is higher than the energy level E2_{S1} of a second organic compound in the lowest excited singlet state, that at least one energy level of the second organic compound between the energy levels E1_{T1} and E2_{S1}, and that light is emitted from the second organic compound, luminance of emitted light can be increased.

### INDUSTRIAL APPLICABILITY

By using the light-emitting material of the present invention, the energy in the excited triplet state can be efficiently converted into luminescence and a high-luminance organic EL device having durability can be provided.

1. An organic electroluminescent device comprising a light-emitting layer containing two or more organic compounds, wherein out of the organic compounds, two organic compounds are conditioned such that an energy level E1_{T1} of a first organic compound in a lowest excited triplet state is higher than an energy level E2_{S1} of a second organic compound in a lowest excited singlet state, at least one energy level of said second organic compound in an excited triplet state is present between E1_{T1} and E2_{S1}, and light is emitted from the second organic compound.

2. An organic electroluminescent device comprising a light-emitting layer containing three or more organic compounds, wherein out of the organic compounds, three organic compounds are conditioned such that the energy level E1_{T1} of a first organic compound in a lowest excited triplet state is higher than an energy level E2_{S1} of a second organic compound in a lowest excited singlet state, at least one energy level of said second organic compound in a excited triplet state is present between E1_{T1} and E2_{S1}, the energy level E1_{S1} in the lowest excited singlet state and the energy level E1_{T1} in the lowest triplet state of said first organic compound have the following relationship with an energy level E3_{S1} in a lowest excited singlet state and an energy level E3_{T1} in a lowest excited triplet state of a third organic compound:
E3_{S1}>E1_{S1}
E3_{T1}>E1_{T1}
and light is emitted from the second organic compound.

3. An organic electroluminescent device comprising an anode, a light-emitting layer described in claim 1 or 2 and a cathode in this order.

4. An organic electroluminescent device comprising an anode, a hole transport layer, a light-emitting layer described in claim 1 or 2, an electron transport layer and a cathode in this order.

5. The organic electroluminescent device as claimed in any one of claims 1 to 4, wherein the light emission from said second organic compound is fluorescence.

6. The organic electroluminescent device as claimed in any one of claims 1 to 5, wherein said first organic compound is a transition metal complex.

7. The organic electroluminescent device as claimed in any one of claims 1 to 5, wherein said first organic compound is a rare earth metal complex.

8. A light-emitting material comprising a light-emitting layer containing two or more organic compounds, wherein out of the organic compounds, two organic compounds are conditioned such that an energy level E1_{T1} of a first organic compound in a lowest excited triplet state is higher than an energy level E2_{S1} of a second organic compound in the lowest excited singlet state, at least one energy level of said second organic compound in an excited triplet state is present between E1_{T1} and E2_{S1}, and light is emitted from the second organic compound.

9. A light-emitting material comprising a light-emitting layer containing three or more organic compounds, wherein out of the organic compounds, three organic compounds are conditioned such that an energy level E1_{T1} of a first organic compound in a lowest excited triplet state is higher than an energy level E2_{S1} of a second organic compound in a lowest excited singlet state, at least one energy level of said second organic compound in an excited triplet state is present between E1_{T1} and E2_{S1}, the energy level E1_{S1} in the lowest excited singlet state and the energy level E1_{T1} in the lowest triplet state of said first organic compound have the following relationship with an energy level E3_{S1} in the lowest excited singlet state and an energy level E3_{T1} in the lowest excited triplet state of a third organic compound:
E3_{S1}>E1_{S1}
E3_{T1}>E1_{T1}
and light is emitted from the second organic compound.

10. The light-emitting material as claimed in claims 8 or 9, wherein the light emission from said second organic compound is fluorescence.

11. The light-emitting material as claimed in any one of claims 8 to 10, wherein said first organic compound is a transition metal complex.

12. The light-emitting material as claimed in any one of claims 8 to 10, wherein said first organic compound is a rare earth metal complex.
